(19) United States
(12) Patent Application Publication
(10) Pub. No.: US 2010/0186768 A1
(43) Pub. Date: Jul. 29, 2010

(54) FOREIGN MATTER REMOVING METHOD FOR LITHOGRAPHIC PLATE AND METHOD FOR MANUFACTURING LITHOGRAPHIC PLATE

(76) Inventor: Shingo KANAMITSU, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/641,066

(22) Filed: Dec. 17, 2009

(30) Foreign Application Priority Data
Jan. 26, 2009 (JP) 2009-014238

(51) Int. Cl. C25F 3/00; B44C 1/22

(52) U.S. Cl. 134/1.1; 216/66

(57) ABSTRACT

A method for removing foreign matter attached to a photomask, includes: irradiating the foreign matter with an electron beam in an etching gas atmosphere in which the foreign matter or a bottom surface of the photomask is etched by irradiation with the electron beam; or irradiating the foreign matter with the electron beam in a deposition gas atmosphere in which a solid material is generated by irradiation with the electron beam to deposit the solid material on the foreign matter, and applying a force to the solid material with an AFM probe.

### CROSS-REFERENCE TO RELATED APPLICATIONS

This application is based upon and claims the benefit of priority from the prior Japanese Patent Application No. 2009-14238, filed on Jan. 26, 2009; the entire contents of which are incorporated herein by reference.

### BACKGROUND OF THE INVENTION

1. Field of the Invention

This invention relates to a foreign matter removing method for a lithographic plate and a method for manufacturing a lithographic plate.

2. Background Art

In the process for manufacturing a photomask used for manufacturing a semiconductor device, foreign matter attached to the pattern surface of the photomask is typically removed by wet cleaning. Wet cleaning is broadly classified into a method of removing foreign matter by using chemical properties of a cleaning liquid and a method of removing foreign matter by a physical force exerted through a cleaning liquid. For instance, the former includes cleaning with a mixed liquid of sulfuric acid and hydrogen peroxide solution, and the latter includes ultrasonic cleaning. Typically, a number of such methods are combined to construct a sequence of cleaning process.

However, there are also numerous kinds of foreign matter, which cannot be removed by such a cleaning process. Typically, such foreign matter cannot be removed even by repetition of the aforementioned cleaning process because of its high resistance to the chemical properties of the cleaning liquid and high adhesive force to the photomask. However, foreign matter must be completely removed from the photomask. This is because, if any foreign matter remains on the photomask, when a semiconductor device is manufactured using this photomask, the image of the foreign matter is transferred to the semiconductor device and causes defects in the semiconductor device. However, if the cleaning force of the cleaning process is excessively strong, the fine pattern formed on the photomask is unfortunately destroyed.

In this context, JP-A 2005-084582 (Kokai), for instance, discloses a method for removing such foreign matter, which cannot be removed by the normal cleaning process, by scratching it with an AFM (atomic force microscope) probe. In this method, the probe is brought into direct contact with the foreign matter to apply a mechanical force to the foreign matter and strip it from the photomask. However, in this technique, in order to remove foreign matter attached in a recess of the pattern, the probe needs to be inserted into the recess. Hence, with the downscaling of the pattern of the photomask, a thinner probe with a more pointed tip is required, but the probe has limitations in sharpening the probe and reducing its diameter. Even if a sufficiently thin probe with a sufficiently pointed tip can be manufactured, contact of such a probe with a photomask damages the photomask.

### SUMMARY OF THE INVENTION

According to an aspect of the invention, there is provided a foreign matter removing method for a lithographic plate for removing foreign matter attached to the lithographic plate, including: irradiating the foreign matter with a charged particle beam in an etching gas atmosphere in which the foreign matter or a bottom surface of a recess of the lithographic plate is etched by irradiation with the charged particle beam.

According to another aspect of the invention, there is provided a foreign matter removing method for a lithographic plate for removing foreign matter attached to the lithographic plate, including: irradiating the foreign matter with a charged particle beam in a deposition gas atmosphere in which a solid material is generated by irradiation with the charged particle beam, thereby depositing the solid material on the foreign matter; and applying a force to the solid material.

According to still another aspect of the invention, there is provided a method for manufacturing a lithographic plate, including: fabricating a patterned body of the lithographic plate; and removing foreign matter attached to the patterned body by irradiating the foreign matter with a charged particle beam.

### BRIEF DESCRIPTION OF THE DRAWINGS

FIGS. 1A to 1C are cross-sectional views illustrating a lithographic plate subjected to foreign matter removal in a first embodiment of the invention, where FIG. 1A shows a photomask, FIG. 1B shows an EUV mask, and FIG. 1C shows a nano-imprint template;

FIG. 2 is a block diagram illustrating a foreign matter removing apparatus used in the first embodiment;

FIG. 3 is a cross-sectional view illustrating the patterned body of a photomask with foreign matter attached thereto;

FIG. 4A is a schematic view illustrating a SEM image of a photomask containing the foreign matter, and FIG. 4B is a schematic view illustrating a back-scattered electron image of the photomask containing the foreign matter;

FIGS. 5A and 5B are diagrams illustrating an electron beam irradiation method in the embodiment, where FIG. 5A is a side view, and FIG. 5B is a plan view;

FIGS. 6A to 6D are diagrams illustrating a change of the foreign matter by electron beam irradiation, where FIG. 6A is a plan view showing the state before electron beam irradiation, FIG. 6B is a side view thereof, FIG. 6C is a plan view showing the state after a certain duration of electron beam irradiation, and FIG. 6D is a side view thereof;

FIGS. 7A to 7D are diagrams illustrating a change of the foreign matter by electron beam irradiation, where FIG. 7A is a plan view showing the state before electron beam irradiation, FIG. 7B is a side view thereof, FIG. 7C is a plan view showing the state after a certain duration of electron beam irradiation, and FIG. 7D is a side view thereof;

FIGS. 8A and 8B are cross-sectional views illustrating a method for etching a glass substrate around the foreign matter by an electron beam;

FIGS. 9A to 9D are side views illustrating a foreign matter removing method according to a second embodiment of the invention, where FIG. 9A shows the process of depositing a solid material on the foreign matter, FIG. 9B shows the state in which the solid material is deposited on the foreign matter, FIG. 9C shows the process of wet cleaning, and FIG. 9D shows the scratching process using a probe;

FIG. 10 is a flow chart illustrating a method for manufacturing a lithographic plate according to a third embodiment of the invention;

FIGS. 11A to 11D are process cross-sectional views illustrating the method for manufacturing a lithographic plate according to the embodiment; and

FIG. 12 is a flow chart detailing the foreign matter removing process shown in FIG. 10.

### DETAILED DESCRIPTION OF THE INVENTION

Embodiments of the invention will now be described with reference to the drawings.

At the outset, a first embodiment of the invention is described.

This embodiment relates to a foreign matter removing method for a lithographic plate.

First, a lithographic plate subjected to foreign matter removal in this embodiment is described.

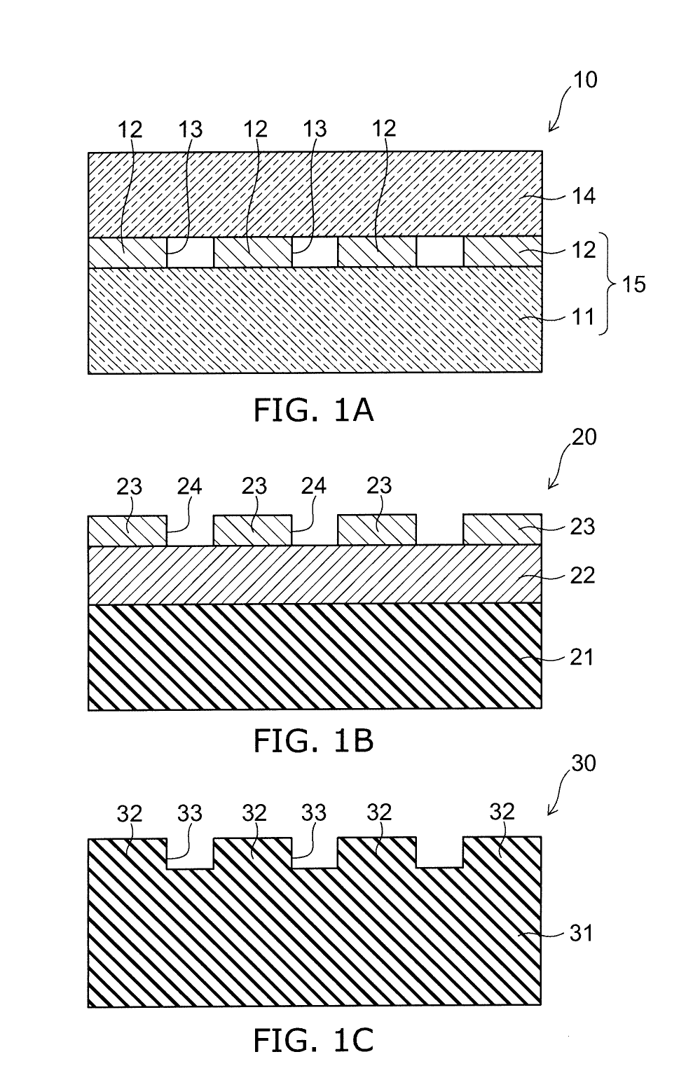

FIGS. 1A to 1C are cross-sectional views illustrating a lithographic plate subjected to foreign matter removal in this embodiment, where FIG. 1A shows a photomask, FIG. 1B shows an EUV mask, and FIG. 1C shows a nano-imprint template.

The lithographic plate is an original plate for patterning a mask used to etch a fine pattern in the process for manufacturing a structure with the fine pattern formed therein, such as semiconductor devices, printed circuit boards, printing matrixes, liquid crystal display devices, and plasma display devices. Examples of this mask include a resin-based mask. Examples of the methods for patterning a mask include a photolithography method in which an evenly formed photosensitive resist film is selectively irradiated with light for exposure and then developed, and a nano-imprint method in which a mold is pressed against a resin film to form a pattern.

The lithographic plate used for the photolithography method is a mask selectively transmitting or reflecting exposure light, such as a photomask for which ultraviolet radiation is used as exposure light, and an EUV mask for which EUV (extreme ultraviolet) radiation is used as exposure light. On the other hand, the lithographic plate used for the nano-imprint method is a nano-imprint template.

As shown in FIG. 1A, in a photomask 10 for ultraviolet radiation, for instance, a light-blocking film 12 illustratively made of molybdenum silicon (MoSi) is selectively formed on a translucent substrate 11 illustratively made of a glass. Thus, a pattern made of the light-blocking film 12 is formed on the translucent substrate 11, and the region on the translucent substrate 11 where the light-blocking film 12 is not placed constitutes a recess 13. A translucent pellicle 14 is stuck entirely onto the translucent substrate 11 so as to cover the light-blocking film 12. In the following, the portion of the photomask 10 other than the pellicle 14 is referred to as a patterned body 15. The photomask 10 is illustratively a phase shift mask, such as a half-tone mask.

As shown in FIG. 1B, in an EUV mask 20 for EUV radiation, for instance, a reflection film 22 made of a multilayer film with molybdenum films and silicon films alternately laminated therein is provided entirely on a support substrate 21 made of a low-expansion glass, and an absorption film 23 for absorbing EUV is selectively formed on the reflection film 22. Thus, a pattern made of the absorption film 23 is formed on the reflection film 22, and the region on the reflection film 22 where the absorption film 23 is not placed constitutes a recess 24.

As shown in FIG. 1C, in a nano-imprint template 30, a protrusion 32 is selectively provided on a plate-like substrate portion 31. The substrate portion 31 and the protrusion 32 are integrally formed from quartz, for instance. Thus, a pattern made of the protrusion 32 is formed on the substrate portion 31, and the region on the substrate portion 31 where the protrusion 32 is not placed constitutes a recess 33.

Thus, in any of the lithographic plates, a protrusion is selectively formed on a plate-like member to realize a pattern, and the portion between the protrusions constitutes a recess. In the process for manufacturing these lithographic plates, foreign matter is often attached into the recess.

Next, a foreign matter removing apparatus used in this embodiment is described.

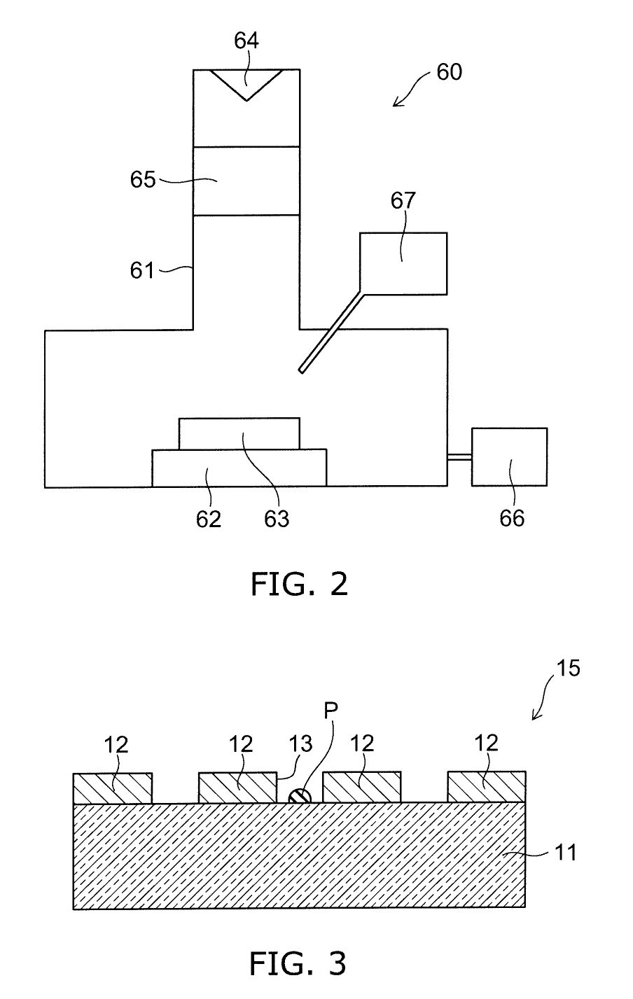

FIG. 2 is a block diagram illustrating a foreign matter removing apparatus used in this embodiment.

As shown in FIG. 2, the foreign matter removing apparatus 60 includes a vacuum chamber 61, in which an XY movable stage 62 is provided. A holding mechanism 63 for holding a lithographic plate (not shown) is mounted on the XY movable stage 62. Furthermore, an electron gun 64 for emitting an electron beam is provided in the vacuum chamber 61, and an optical system 65 for guiding the electron beam emitted from the electron gun 64 to the lithographic plate held on the holding mechanism 63 is provided between the electron gun 64 and the holding mechanism 63. The electron gun 64 and the optical system 65 constitute an electron microscope. Furthermore, the foreign matter removing apparatus 60 includes an exhaust apparatus 66 for evacuating the vacuum chamber 61 and a gas supply system 67 for introducing a gas into the vacuum chamber 61. The foreign matter removing apparatus 60 can illustratively be based on an electron beam repair apparatus for repairing a pattern defect in a photomask.

In the following, a foreign matter removing method for a lithographic plate according to this embodiment is described.

FIG. 3 is a cross-sectional view illustrating the patterned body of a photomask with foreign matter attached thereto.

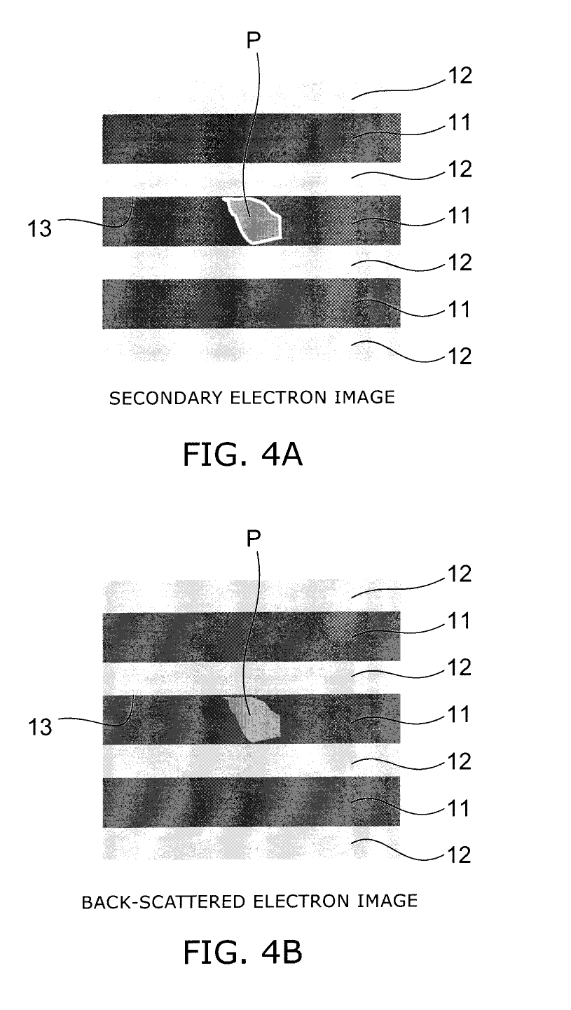

FIG. 4A is a schematic view illustrating a SEM (scanning electron microscope) image of a photomask containing the foreign matter, and FIG. 4B is a schematic view illustrating a back-scattered electron image of the photomask containing the foreign matter.

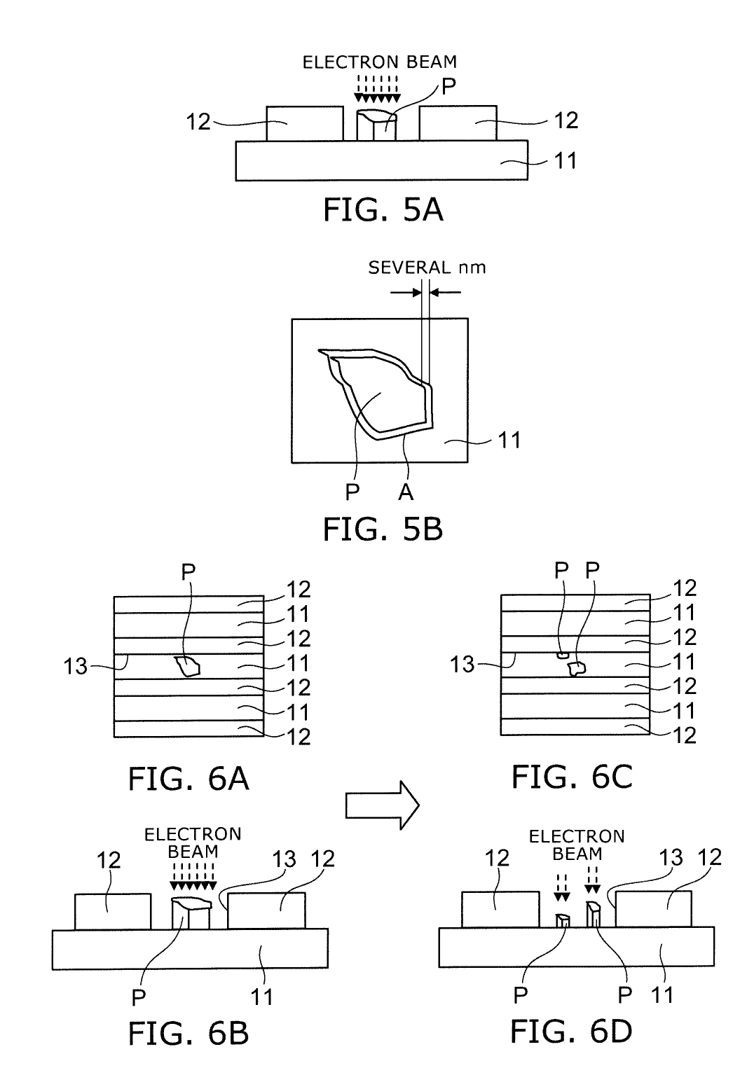

FIGS. 5A and 5B illustrate an electron beam irradiation method in this embodiment, where FIG. 5A is a side view, and FIG. 5B is a plan view.

FIGS. 6A to 6D illustrate the change of the foreign matter by electron beam irradiation, where FIG. 6A is a plan view showing the state before electron beam irradiation, FIG. 6B is a side view thereof, FIG. 6C is a plan view showing the state after a certain duration of electron beam irradiation, and FIG. 6D is a side view thereof.

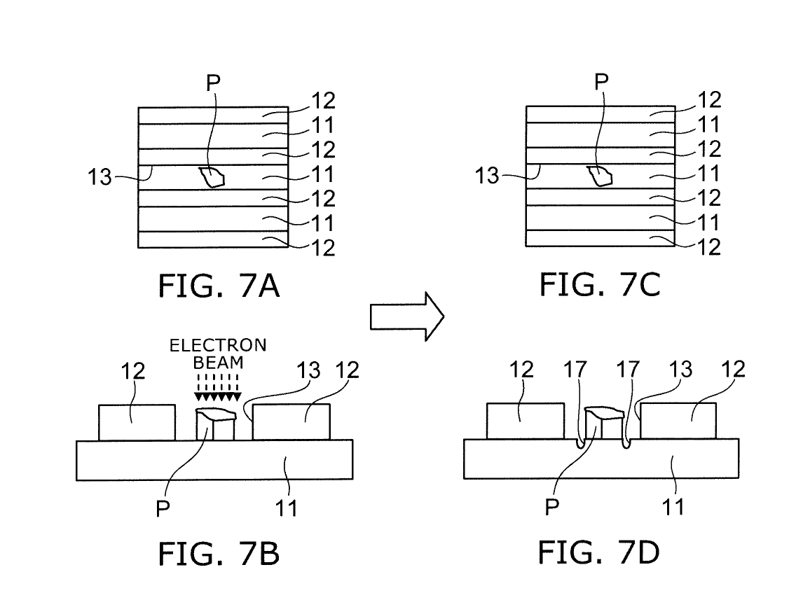

FIGS. 7A to 7D illustrate the change of the foreign matter by electron beam irradiation, where FIG. 7A is a plan view showing the state before electron beam irradiation, FIG. 7B is a side view thereof, FIG. 7C is a plan view showing the state after a certain duration of electron beam irradiation, and FIG. 7D is a side view thereof.

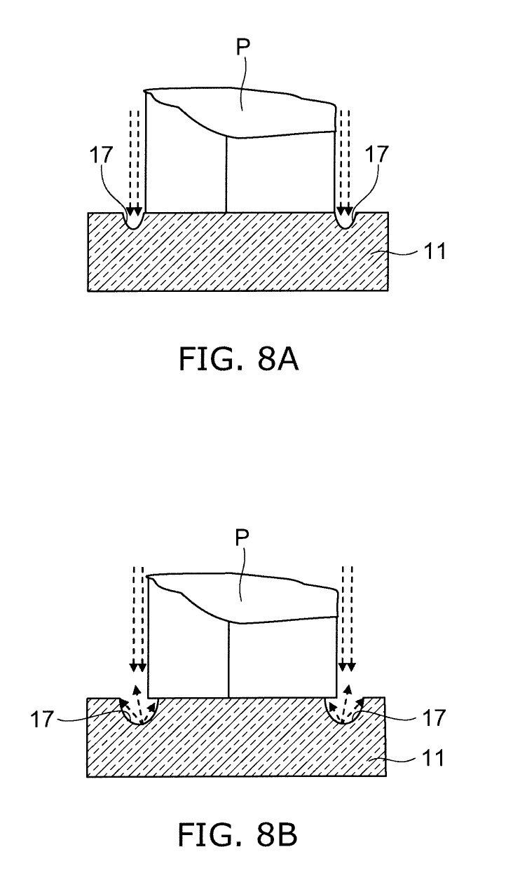

FIGS. 8A and 8B are cross-sectional views illustrating a method for etching a glass substrate around the foreign matter by an electron beam.

As shown in FIG. 3, in this embodiment, the photomask 10 shown in FIG. 1A is used as a lithographic plate. The foreign matter removing method according to this embodiment is performed on a patterned body 15 before a pellicle 14 is stuck thereto. It is assumed that in the patterned body 15, foreign matter P generated in the manufacturing process is attached to the upper surface of the translucent substrate 11 in a recess 13. This foreign matter P cannot be removed by the normal cleaning process.

First, as shown in FIG. 2, the patterned body 15 of the photomask 10 is placed on the holding mechanism 63 of the foreign matter removing apparatus 60. Then, the vacuum chamber 61 is air-sealed, and the exhaust apparatus 66 is operated to evacuate the vacuum chamber 61. Next, while the photomask is observed by the SEM, the XY movable stage 62 is actuated to position the foreign matter P at the center of the SEM observation region.

Next, as shown in FIG. 4A, a SEM image of a region including the foreign matter P is obtained. Thus, the coordinates of the foreign matter P in the SEM image are obtained, and the shape of the foreign matter P is observed. Furthermore, as shown in FIG. 4B, an image formed by back-scattered electrons is also obtained. The amount of emission of back-scattered electrons depends on the kind of the material. Hence, if the brightness of the foreign matter P in the back-scattered electron image is different from both the brightness of the translucent substrate 11 and the brightness of the light-blocking film 12, the foreign matter P proves to be made of a third material, which is not a glass nor molybdenum silicon, and it is identified as other than a pattern defect, that is, a defect made of the light-blocking film 12 running off into the recess 13. This technique is useful particularly for a small observation object because it is then difficult to determine whether the observation object is foreign matter or a pattern defect on the basis of the SEM image. If the brightness of the foreign matter P in the back-scattered electron image is equivalent to the brightness of the light-blocking film 12, it may be identified as a pattern defect and subjected to normal repair processing.

When the foreign matter P is identified as other than the light-blocking film 12, the foreign matter P is etched. More specifically, the vacuum chamber 61 is supplied with an etching gas by the gas supply system 67 and filled with an etching gas atmosphere. Then, the foreign matter P and the translucent substrate 11 therearound are irradiated with an electron beam by the electron gun 64.

The etching gas atmosphere is an atmosphere in which the foreign matter P or the bottom surface of the recess 13, i.e., the translucent substrate 11, of the patterned body 15 is etched by electron beam irradiation. Typically, the composition of the foreign matter P is unknown, and hence, before etching, it is unknown whether the foreign matter P is etched by electron beam irradiation in an atmosphere. Thus, the etching gas atmosphere is preferably an atmosphere in which at least the translucent substrate 11 is etched. The etching gas is illustratively made of a halogen compound, such as a fluorine compound or chlorine compound. The fluorine compound is illustratively xenon difluoride gas (XeF₂), and the chlorine compound is illustratively chlorine gas (Cl₂).

Furthermore, as shown in FIGS. 5A and 5B, the position of the outer edge of the irradiation region A to be irradiated with the electron beam is expanded from the outer edge of the foreign matter P by approximately several nm as viewed from above, that is, from the electron gun 64 side. Here, the dose amount of the electron beam required for processing is difficult to determine before irradiation because it depends on the kind of the foreign matter. Thus, the condition is adapted to the foreign matter in accordance with the observed variation of the amount of secondary electrons and the amount of back-scattered electrons.

Thus, the foreign matter P and the translucent substrate 11 therearound are irradiated with an electron beam in an etching gas atmosphere to raise the etching gas to an excited state, allowing the etching gas to react with and etch at least one of the foreign matter P and the glass substrate 11.

Then, if the foreign matter P, which had a certain size before electron beam irradiation as shown in FIGS. 6A and 6B, is reduced by the electron beam irradiation as shown in FIGS. 6C and 6D, then the irradiation region A of the electron beam is made smaller in accordance with the size of the foreign matter P. For instance, electron beam irradiation and SEM observation of the foreign matter P are alternately repeated, and redefinition of the irradiation region A is repeated so that only the foreign matter P and its periphery are irradiated with the electron beam. Then, if the foreign matter P has disappeared, the electron beam irradiation is stopped. Thus, the foreign matter shrinking by electron beam irradiation can be addressed in the same manner as a pattern defect formed by run-off of the light-blocking film.

On the other hand, as shown in FIGS. 7A to 7D, if the foreign matter P does not shrink even by electron beam irradiation, the electron beam irradiation is stopped when the dose amount of the electron beam reaches a certain value. In this case, the foreign matter P is not etched, but the translucent substrate 11 around the foreign matter P is etched. More specifically, first, as shown in FIG. 8A, the portion of the translucent substrate 11 located around the foreign matter P is etched by the electron beam applied by the electron gun 64, and a groove 17 is formed around the foreign matter P. Next, as shown in FIG. 8B, secondary electrons and back-scattered electrons emitted from the translucent substrate 11 excite the etching gas, which etches the inner surface of the groove 17 and expands the groove 17. Consequently, the portion of the translucent substrate 11 facing the bottom surface of the foreign matter P is also partly removed.

After the electron beam irradiation is stopped, the etching gas is exhausted from the vacuum chamber 61, and the patterned body 15 is extracted from the vacuum chamber 61. Then, the patterned body 15 is wet cleaned. This wet cleaning can illustratively be cleaning based on the chemical reaction with a mixed liquid of sulfuric acid and hydrogen peroxide solution, or ultrasonic cleaning, or cleaning using these in combination. At this time, the cleaning liquid reaches the bottom surface of the foreign matter P through the groove 17, and penetrates between the foreign matter P and the translucent substrate 11, hence enhancing the cleaning effect. Consequently, the foreign matter P can be removed with high probability.

Here, the depth of the groove 17 affects the effect of the subsequent wet cleaning and the performance of the photomask. More specifically, an excessively shallow groove 17 makes insufficient the cleaning effect of wet cleaning. Conversely, an excessively deep groove 17 may affect light exposure at the point of use although the cleaning effect is increased. Thus, preferably, an optimal digging depth corresponding to the size of the foreign matter P and the pattern size of the light-blocking film 12 is experimentally determined beforehand. By way of example, if the translucent substrate 11 is formed from a glass, the etching gas is xenon difluoride (XeF₂) gas, and the electron beam has an acceleration voltage of 1 kV and a dose amount of 0.7 C/cm², then the depth of the groove 17 is approximately 10 nm. Here, the width of the recess 13 is illustratively 180 nm, and the thickness of the light-blocking film 12 is illustratively 70 nm.

Next, the effect of this embodiment is described.

In this embodiment, if the etching gas reacts with the foreign matter by electron beam irradiation, the foreign matter can be directly etched and be removed. Here, the irradiation range of the electron beam can be reduced in accordance with the shrinkage of the foreign matter to suppress damage to the translucent substrate by the electron beam. Furthermore, even if the etching gas does not react with the foreign matter, the translucent substrate around the foreign matter can be dug to increase the cleaning effect of the subsequent wet cleaning and remove the foreign matter with high probability. Here, the electron beam can be narrowed to an extremely small beam diameter such as approximately several nm. Hence, even in a photomask with a fine pattern formed thereon, it is possible to remove foreign matter while suppressing damage to the photomask itself. Furthermore, wet cleaning after the electron beam irradiation can be performed in a conventional manner, and hence there is no need to specially develop a new cleaning technique.

In this embodiment, the etching gas is illustratively a gas, which can etch at least the translucent substrate 11, but the invention is not limited thereto. If the composition of the foreign matter is known beforehand, it is possible to use any gas, which can etch the foreign matter. Furthermore, in the case where the composition of the foreign matter is unknown, a useful etching gas may be found by try and error. For instance, such a gas as oxygen or water, which is not normally used as an etching gas but reacts with carbon-containing materials, may be useful.

In this embodiment, if the size of the foreign matter does not change by electron beam irradiation, wet cleaning is illustratively performed after the electron beam irradiation. However, the invention is not limited thereto. For instance, it is also possible to perform dry cleaning, such as spraying dry ice particles.

Next, a second embodiment of the invention is described.

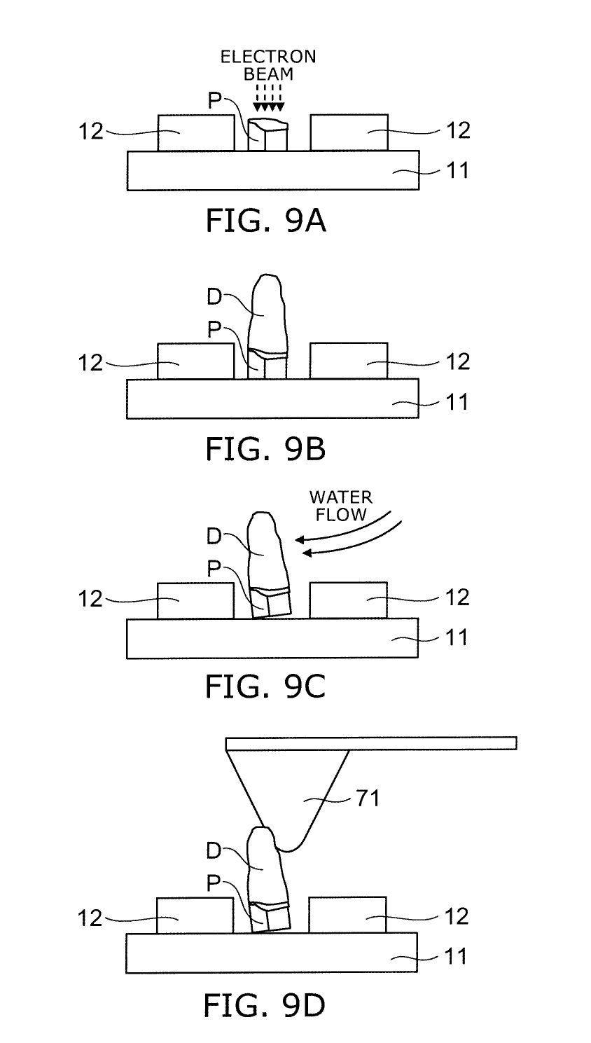

FIGS. 9A to 9D are side views illustrating a foreign matter removing method according to this embodiment, where FIG. 9A shows the process of depositing a solid material on the foreign matter, FIG. 9B shows the state in which the solid material is deposited on the foreign matter, FIG. 9C shows the process of wet cleaning, and FIG. 9D shows the scratching process using a probe.

The lithographic plate subjected to foreign matter removal in this embodiment is a photomask as in the above first embodiment. Furthermore, the foreign matter removing apparatus used in this embodiment is also the same as that in the above first embodiment.

First, the patterned body 15 (see FIG. 3) of the photomask is placed on the holding mechanism 63 (see FIG. 2) of the foreign matter removing apparatus 60. Then, a SEM image of a region including the foreign matter P is obtained, and the coordinates of the foreign matter P are obtained.

Next, as shown in FIGS. 2 and 9A, the vacuum chamber 61 is supplied with a deposition gas by the gas supply system 67 and filled with a deposition gas atmosphere. The deposition gas atmosphere is an atmosphere in which a solid material is generated by electron beam irradiation, and illustratively an atmosphere containing TEOS (tetraethoxysilane, or tetraethyl orthosilicate, Si(OC₂H₅)₄), or an atmosphere containing an aromatic hydrocarbon such as benzene, styrene, or naphthalene. In this state, an electron beam is directed at the foreign matter P.

Thus, as shown in FIG. 9B, the deposition gas is decomposed by electron beam irradiation, and a solid material is deposited on the foreign matter P to form a deposition film D. Here, the deposition film D may be formed so as to cover the foreign matter P. The solid material forming the deposition film D can be any material as long as it can be accurately deposited in a small region on or over the foreign matter P and has high adhesiveness to the foreign matter P, but it is preferably a material, which can be easily generated by the foreign matter removing apparatus 60 converted from a mask repair apparatus. For instance, if TEOS is used as a deposition gas, the deposited solid material is silicon oxide (SiO₂). If an aromatic hydrocarbon is used as a deposition gas, the solid material is carbon (C). Alternatively, the solid material may be chromium (Cr). Furthermore, the upper end portion of the deposition film D is preferably located above the upper surface of the light-blocking film 12.

Next, as shown in FIG. 9C, the patterned body 15 is wet cleaned. This wet cleaning is such cleaning as applying a mechanical force to the foreign matter P and the deposition film D through a cleaning liquid, and is illustratively ultrasonic cleaning. In this wet cleaning, the foreign matter P has been combined with the deposition film D and increased in height. This increases the resistance of water flow and the area receiving the shock wave due to cavitations generated by ultrasonic vibration. Thus, a strong mechanical force acts on the deposition film D made of the solid material and the foreign matter P, and can detach the deposition film D together with the foreign matter P from the translucent substrate 11. Consequently, the foreign matter P can be removed from the photomask 10.

Alternatively, as shown in FIG. 9D, a needle-like member, such as an AFM probe 71, can be laterally brought into contact with the deposition film D to apply a force thereto. This can detach the deposition film D together with the foreign matter P from the translucent substrate 11, and remove the foreign matter P from the photomask 10. Here, if the total height of the foreign matter P and the deposition film D is higher than the thickness of the light-blocking film 12, the upper end portion of the deposition film D protrudes from the upper surface of the light-blocking film 12 as viewed laterally. Thus, the probe 71 can be brought into contact with the deposition film D without entering the recess 13. Thus, even if the probe 71 cannot enter the recess 13 because the light-blocking film 12 has a fine pattern, the probe 71 can be used to remove the foreign matter P. The probe 71 is illustratively a diamond probe fabricated by sharpening the tip of a diamond chip into a triangular pyramid with an apex angle of approximately 30° to 50°. This is because a diamond probe has higher strength than a silicon probe and is more resistant to breakage and wear.

Furthermore, before and after the aforementioned removal of the foreign matter with an AFM probe, wet cleaning shown in FIG. 9C may be performed. If wet cleaning is performed before foreign matter removal with a probe, the number of foreign particles individually removed by contact with the probe can be reduced. If wet cleaning is performed after foreign matter removal with a probe, the foreign matter and the deposition film detached from the translucent substrate by contact with the probe can be reliably removed from the photomask.

Thus, according to this embodiment, also from a photomask with a fine pattern formed thereon, foreign matter can be easily removed without damage to the photomask. The effect of this embodiment other than the foregoing is the same as that of the above first embodiment.

The above first and second embodiments can be practiced also in combination. In this case, the order of processing is arbitrary. For instance, the etching process described in the first embodiment can be followed by the deposition process described in the second embodiment, or the deposition process can be followed by the etching process. Furthermore, these processes may be repetitively performed.

In the above first and second embodiments, an electron beam is illustratively used as a charged particle beam. However, the invention is not limited thereto. An ion beam may be used as a charged particle beam. However, to suppress damage to the photomask, an electron beam is more preferably used than an ion beam. If an ion beam is used, it is preferable to use ions of the lightest possible element.

Next, a third embodiment of the invention is described.

This embodiment relates to a method for manufacturing a lithographic plate.

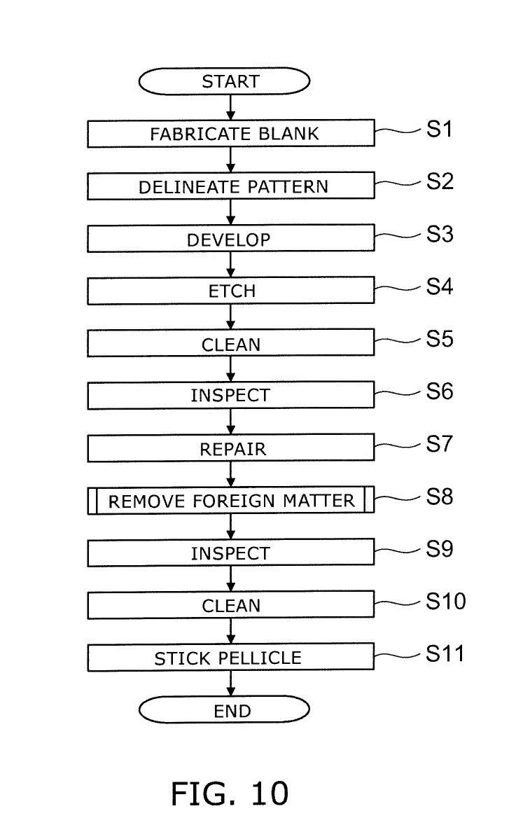

FIG. 10 is a flow chart illustrating the method for manufacturing a lithographic plate according to this embodiment.

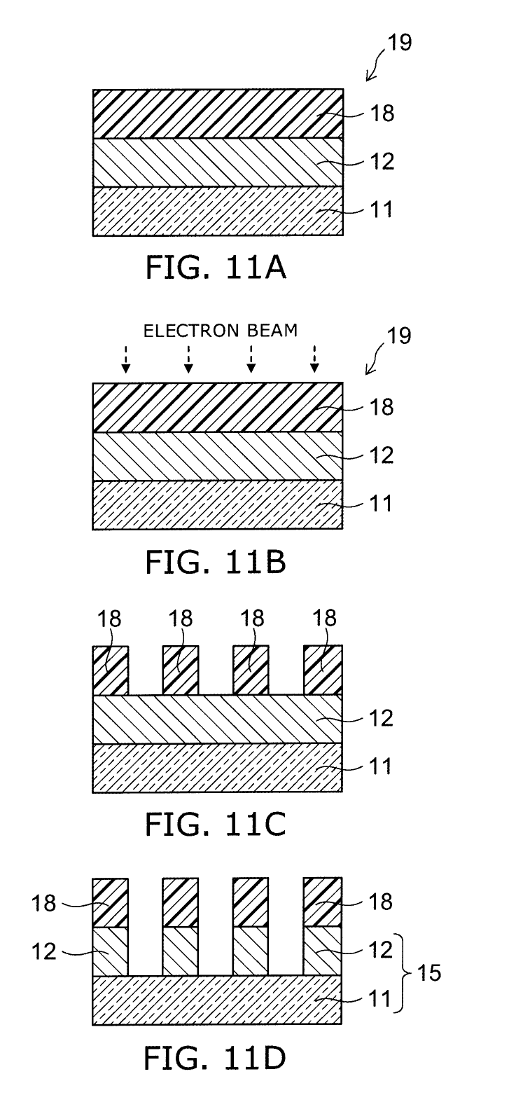

FIGS. 11A to 11D are process cross-sectional views illustrating the method for manufacturing a lithographic plate according to this embodiment.

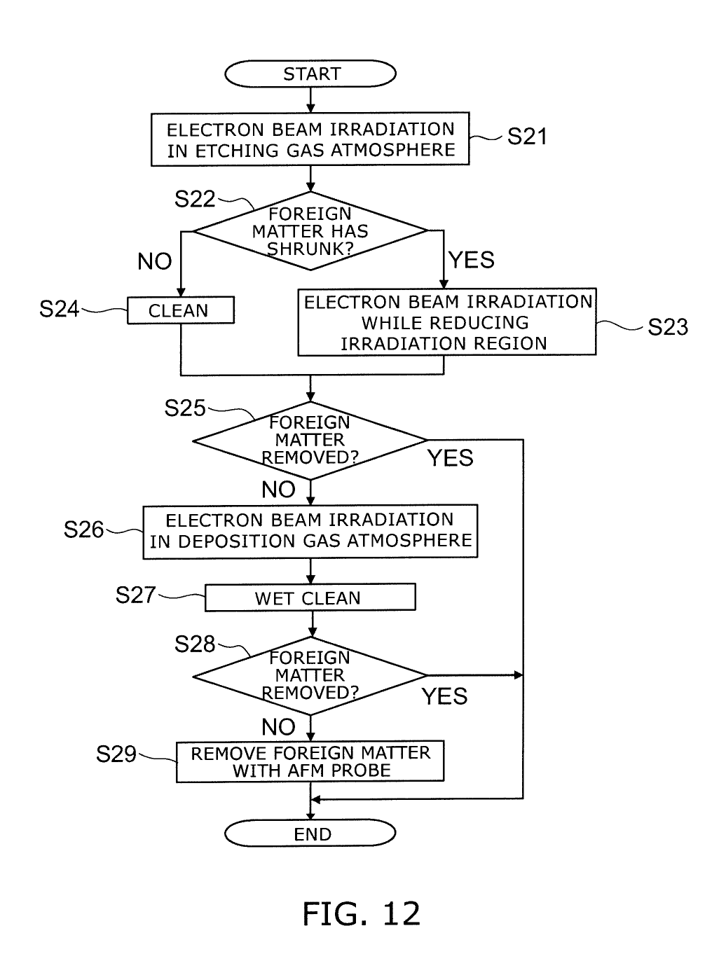

FIG. 12 is a flow chart detailing the foreign matter removing process shown in FIG. 10.

In the description of this embodiment, a photomask is taken as an example of the lithographic plate.

First, as shown in step S1 of FIG. 10 and FIG. 11A, a light-blocking film 12 illustratively made of molybdenum silicon is formed entirely on a translucent substrate 11 illustratively made of a glass. Subsequently, a resist film 18 made of a photoresist material sensitive to an electron beam is formed entirely on the light-blocking film 12. Thus, a blank 19 is fabricated. The blank 19 is not patterned.

Next, as shown in step S2 of FIG. 10 and FIG. 11B, the resist film 18 is selectively irradiated with an electron beam for pattern delineation. Thus, the portion of the resist film 18 irradiated with the electron beam reacts thereto.

Next, as shown in step S3 of FIG. 10 and FIG. 11C, the resist film 18 is developed. Thus, the resist film 18 is selectively removed and patterned.

Next, as shown in step S4 of FIG. 10 and FIG. 11D, the patterned resist film 18 is used as a mask to etch the light-blocking film 12. Thus, the light-blocking film 12 is selectively removed and patterned. Subsequently, the resist film 18 is removed, and thereby a patterned body 15 is fabricated as a photomask precursor. At this point, numerous foreign particles are attached to the patterned body 15, and in many cases, pattern defects also exist.

Next, as shown in step S5 of FIG. 10, the patterned body 15 is cleaned. This cleaning is illustratively performed by combining various wet etching processes as described in the first embodiment. Thus, most of the foreign matter attached to the patterned body 15 is removed, but foreign matter having high chemical resistance and strong adhesive force is not removed. Pattern defects are also not removed.

Next, as shown in step S6, the patterned body 15 is inspected. Thus, the coordinates of the residual foreign matter and pattern defects are obtained.

Next, as shown in step S7, the patterned body 15 is repaired. More specifically, if the light-blocking film 12 is formed in a region where it should not exist, the light-blocking film 12 formed in this region is removed by etching. On the other hand, if no light-blocking film 12 is formed in a region where it should exist, the light-blocking film 12 is deposited in this region. Thus, the pattern defects are repaired.

Next, as shown in step S8, the residual foreign matter is removed. In this foreign matter removing process, the foreign matter removing methods according to the above first and second embodiments are practiced in combination. Thus, the foreign matter attached to the patterned body 15 is removed. The detailed content of step S8 is described later.

Next, as shown in step S9, the patterned body 15 is inspected. Then, if no foreign matter and pattern defects are found, the flow proceeds to step S10, where the patterned body 15 is cleaned. If any foreign matter is found, the flow may return to step S8, and if any pattern defect is found, the flow may return to step S7.

Next, as shown in step S11 of FIG. 10 and FIG. 1A, a pellicle 14 is stuck to the upper surface of the patterned body 15. Thus, a photomask 10 is manufactured.

Next, the foreign matter removing process shown in the above step S8 is described in detail.

First, as shown in step S21 of FIG. 12 and FIGS. 5A and 5B, by the method described in the above first embodiment, the foreign matter P attached to the patterned body 15 is irradiated with an electron beam in an etching gas atmosphere.

Next, as shown in step S22, by SEM observation and the like, it is determined whether the foreign matter has shrunk. If the foreign matter has shrunk as shown in FIG. 6, the flow proceeds to step S23, where the foreign matter is irradiated with the electron beam until it disappears while the irradiation range of the electron beam is reduced in accordance with the shrinkage of the foreign matter. On the other hand, if the foreign matter has not shrunk as shown in FIG. 7, the flow proceeds to step S24, where wet cleaning is performed.

Next, as shown in step S25, the patterned body 15 is inspected. If the foreign matter has been removed, the foreign matter removing process is terminated. On the other hand, if the foreign matter has not been removed, the flow proceeds to step S26.

In step S26, as shown in FIG. 9A, by the method described in the above second embodiment, the foreign matter attached to the patterned body 15 is irradiated with an electron beam in a deposition gas atmosphere. Thus, as shown in FIG. 9B, a solid material is deposited on the foreign matter P to form a deposition film D.

Next, as shown in step S27 of FIG. 12 and FIG. 9C, the patterned body 15 is wet cleaned. Thus, a force acts on the deposition film D and the foreign matter P through a cleaning liquid.

Next, as shown in step S28, the patterned body 15 is inspected. If the foreign matter has been removed, the foreign matter removing process is terminated. On the other hand, if the foreign matter has not been removed, the flow proceeds to step S29.

In step S29, as shown in FIG. 9D, an AFM probe 71 is laterally brought into contact with the deposition film D and pressed thereto. Thus, the foreign matter P and the deposition film D are detached and removed from the translucent substrate 11. Then, the foreign matter removing process is terminated.

According to this embodiment, as shown in FIG. 10, the process for manufacturing a photomask includes the foreign matter removing process (step S8) after the normal cleaning (step S5), inspection (step S6), and repair (step S7) and before sticking a pellicle (step S11). Thus, hard-to-remove foreign matter present on the pattern surface of the photomask can be easily removed to manufacture a photomask free from foreign matter and defects at low cost and short TAT (turn around time).

Furthermore, in the configuration of this embodiment, as shown in FIG. 12, the foreign matter removing process is combined with the above first and second embodiments. Thus, depending on the result of an operation, the subsequent operation is selected so that whatever kind of foreign matter can be removed efficiently and almost unfailingly.

The above procedure of the foreign matter removing process (see FIG. 12) is illustrative only, and the foreign matter removing process may be performed in other procedures. Furthermore, after the final cleaning (step S10), the above foreign matter removing process (step S8) may be additionally performed.

Furthermore, in the description of this embodiment, the method for manufacturing a photomask is taken as an example. However, other lithographic plates such as an EUV mask and a nano-imprint template can also be manufactured in a similar method. More specifically, after a patterned body of the lithographic plate is fabricated, foreign matter attached to this patterned body can be removed. In this case, the patterned body is the lithographic plate itself or its precursor after patterning and before the stage where the foreign matter should have been completely removed. Fabrication of the patterned body can be based on conventionally known processes.

The invention has been described with reference to the embodiments. However, the invention is not limited to these embodiments. For instance, those skilled in the art can suitably modify the above embodiments by addition, deletion, or design change of components, or by addition, omission, or condition change of processes, and such modifications are also encompassed within the scope of the invention as long as they fall within the spirit of the invention.

1. A foreign matter removing method for a lithographic plate for removing foreign matter attached to the lithographic plate, comprising:
irradiating the foreign matter with a charged particle beam in an etching gas atmosphere in which the foreign matter or a bottom surface of a recess of the lithographic plate is etched by irradiation with the charged particle beam.

2. The method according to claim 1, further comprising;
cleaning the lithographic plate after the irradiating with the charged particle beam,
the bottom surface around the foreign matter being also irradiated with the charged particle beam.

3. The method according to claim 1, further comprising:
observing the foreign matter, and if the foreign matter has shrunk, redefining an irradiation region of the charged particle beam,
the irradiation with the charged particle beam and the redefinition of the irradiation region being alternately performed.

4. The method according to claim 1, further comprising:
obtaining a back-scattered electron image of the foreign matter before the irradiating with the charged particle beam.

5. The method according to claim 1, wherein the charged particle beam for irradiation is an electron beam.

6. The method according to claim 1, wherein the charged particle beam for irradiation is an ion beam.

7. A foreign matter removing method for a lithographic plate for removing foreign matter attached to the lithographic plate, comprising:
irradiating the foreign matter with a charged particle beam in a deposition gas atmosphere in which a solid material is generated by irradiation with the charged particle beam, thereby depositing the solid material on the foreign matter; and
applying a force to the solid material.

8. The method according to claim 7, wherein
the lithographic plate is patterned so that a protrusion is selectively formed on a plate-like member, and
the depositing the solid material includes depositing the solid material to above an upper surface of the protrusion.

9. The method according to claim 7, wherein the applying the force is performed by bringing a needle-like member into contact with the solid material.

10. The method according to claim 9, wherein a diamond probe is used as the needle-like member.

11. The method according to claim 7, wherein the applying the force is performed by ultrasonic cleaning.

12. The method according to claim 7, further comprising:
wet cleaning the lithographic plate before the depositing the solid material.

13. The method according to claim 7, further comprising:
wet cleaning the lithographic plate after the applying the force.

14. The method according to claim 7, wherein the charged particle beam for irradiation is an electron beam.

15. The method according to claim 7, wherein the charged particle beam for irradiation is an ion beam.

16. A method for manufacturing a lithographic plate, comprising:
fabricating a patterned body of the lithographic plate; and
removing foreign matter attached to the patterned body by irradiating the foreign matter with a charged particle beam.

17. The method according to claim 16, wherein the removing the foreign matter includes irradiating the foreign matter with the charged particle beam in an etching gas atmosphere in which the foreign matter or a bottom surface of a recess of the lithographic plate is etched by irradiation with the charged particle beam.

18. The method according to claim 17, wherein
in the irradiating with the charged particle beam, the bottom surface around the foreign matter is also irradiated with the charged particle beam, and
the removing the foreign matter further includes, after the irradiating with the charged particle beam, cleaning the lithographic plate.

19. The method according to claim 16, wherein the removing the foreign matter includes:
irradiating the foreign matter with the charged particle beam in a deposition gas atmosphere in which a solid material is generated by irradiation with the charged particle beam, thereby depositing the solid material on the foreign matter; and
applying a force to the solid material.

20. The method according to claim 16, wherein the removing the foreign matter includes:
irradiating the foreign matter with a first charged particle beam in an etching gas atmosphere in which the foreign matter or a bottom surface of a recess of the lithographic plate is etched by irradiation with the first charged particle beam;
irradiating the foreign matter with a second charged particle beam in a deposition gas atmosphere in which a solid material is generated by irradiation with the second charged particle beam, thereby depositing the solid material on the foreign matter; and
applying a force to the solid material.
